(19) United States
(12) Patent Application Publication
(10) Pub. No.: US 2007/0219831 A1
(43) Pub. Date: Sep. 20, 2007

(54) Flight risk management system

(76) Inventor: Louis Ge'za Ne'meth, Charlotte, NC (US)

Correspondence Address: Pennington, Moore, Wilkinson, Bell & Dunbar, P.A.;2nd Floor, 215 S. Monroe St, Post Office Box 10095, Tallahassee, FL, 32301, US

(21) Appl. No.: 11/203,923

(22) Filed: Aug. 15, 2005

(51) Int. Cl. G06Q 40/00; G08B 23/00

(52) U.S. Cl. 705/4; 340/963

(57) ABSTRACT

A Flight Risk Management System (“FRMS”). The system provides supplementary preflight and in-flight guidance to relatively inexperienced owner/operators of high performance aircraft. A pilot wishing to enroll in the FRMS must have an aircraft equipped with an in-flight data recorder capable of monitoring the aircraft's state and communicating this state to an FRMS dispatcher. The dispatcher analyzes each flight before its commencement and imposes restrictions designed to promote flight safety. The dispatcher monitors the flight in progress to ensure the pilot's compliance with all directives. For most enrollees, participation in the FRMS is a mandatory condition precedent to the pilot's insurance coverage. Thus, the potential loss of insurance coverage enforces compliance. In the preferred embodiment, the FRMS manages pilot training, pilot performance, aircraft maintenance, and flight risk assessment.

### BACKGROUND OF THE INVENTION

1. Field of the Invention

This invention relates to the field of transportation. More specifically, the invention comprises a system for evaluating and managing risk for high-performance aircraft being flown by relatively inexperienced pilots.

2. Description of the Related Art

High performance aircraft have traditionally been limited to military and commercial aviation operations. In these arenas, all pilots are trained to a uniform high standard. A great deal of operational discretion is therefore left to the individual pilots.

Of course, general aviation aircraft have traditionally been flown by pilots having greatly divergent experience levels. A small and simple general aviation aircraft—such as a Cessna 172—may be flown by a pilot who has just obtained a “Private Pilot” license. While extra experience and training are likely always helpful, pilots of limited experience can fly small and simple general aviation aircraft without unreasonable risk.

Traditionally, the two worlds of “amateur” recreational pilots versus highly-trained professional pilots have not overlapped significantly. Recent advances in aircraft technology, however, will likely blur this line of distinction.

Manufacturers including Cessna, Adam Aircraft, ATG, and Avocet are now developing small jet aircraft possessing remarkable performance. These aircraft—commonly referred to as “very light jets (VLJ's)”—are expected to be delivered within the next one to five years. Most are pressurized, dual-turbofan, four to six seat aircraft. They are designed for single pilot operation. Several are priced below $1,000,000.

These facts mean that the VLJ's can be purchased by recreational or small business pilots. A purchaser who would previously have opted for a well-equipped turboprop-powered Piper Meridian or comparable aircraft can now purchase a VLJ. The performance advantage in such a purchase will be substantial. The more capable VLJs can reach velocities exceeding 500 mph and altitudes exceeding 40,000 feet. While these figures are customary in commercial airline operations, one must realize that airliners are flown by pilots having extensive training and experience. They must be flown “by the numbers,” in large measure because of the advanced performance regime in which they operate.

Another factor favoring the market for VLJ's is the anticipated Small Aircraft Transportation System (SATS). SATS, if implemented, would allow qualified aircraft to avoid the present hub-and-spoke transportation system. Small aircraft would be able to fly point-to-point in a less controlled environment. A VLJ is particularly attractive in this environment, since its great speed and service ceiling allow it to rapidly travel large distances.

Thus, the reader will appreciate that a new level of affordable aircraft performance is now entering the market. Unfortunately however, a general aviation pilot (even one with several thousand hours of single or light-twin aircraft experience) cannot be expected to immediately master the performance of the new VLJ's. This reasonable concern has caused many aviation insurance underwriters to decline coverage for would-be VLJ owner/operators. Thus, a substantial gap has opened in the business environment for operating these new aircraft: There are many pilots who have the desire and the financial means to purchase a VLJ. However, there are no insurance carriers willing to write coverage for those pilots flying those planes (at least at affordable rates). While it is legally permissible for a properly-licensed pilot to fly without insurance coverage, most are unwilling to do so.

A second insurance issue concerns the availability of product liability coverage for the manufacturer itself. In today's litigious environment, adequate product liability insurance must often be secured before venture capital can be expected to flow. For manufacturers developing innovative new aircraft—such as the VLJ's—this is a significant problem.

The aircraft manufacturer is a named defendant in nearly all aircraft accident litigation. In this position, the manufacturer is often compelled to prove a negative; i.e., that no aspect of aircraft performance caused or contributed to the accident. This is often difficult to prove with the information presently available. Thus, a system of accurately recording an aircraft's performance (as separated from a pilot's performance) would be helpful.

The traditional aircraft and pilot management tools used by airlines can provide some insight into a potential solution for this “insurance gap.” Airlines operate their pilots and aircraft in a highly-structured environment. All flights must be cleared by a dispatcher, who helps evaluate the proposed route and various safety factors prior to clearing the flight for takeoff.

The FAA has long required the use of on-board flight data recorders to monitor both pilot and aircraft. These instruments collect a fairly limited amount of data at low sample rates. Some airlines have also employed enhanced flight data recorders as part of a Flight Operations Quality Assurance (FOQA) program. These enhanced records store many more variables. They are regularly scanned in order to detect maneuvers demonstrating a poor flying practice or an engineering/maintenance problem (A significant deviation in pilot performance or in aircraft performance is commonly known as an “exceedance”).

The enhanced flight data recorders are scanned regularly to detect exceedances. However, the data is stripped of information which would reveal the identity of the crew or the pilot actually flying the aircraft. The only person who can connect the exceedance to a specific pilot is a “gatekeeper” designated by the pilot union's flight safety team. If a pilot has a pattern of problems, the gatekeeper will notify the appropriate personnel as to the pilot's identity, and the union and the airline will the take action.

The reader should note that relatively few aircraft are equipped with these enhanced flight data recorders. Thus, they perform a “survey” function for an airline's fleet of aircraft and team of pilots. They are not designed to monitor individual flights in progress.

The flight dispatch system has worked well for the airlines over many years. It is important to realize, though, that the role of the dispatcher in the airline context is relatively limited. Because airline pilots are so highly trained, the dispatcher knows that every pilot on every flight is fully capable of deciding whether the flight has appropriate safety margins in view of the proposed route, fuel, weather, and other conditions. The flight is actually conducted under the co-authority of the dispatcher and the Captain. The limits of the flight are initially expressed from the dispatcher to the Captain in the form of a flight release. If the Captain in his or her discretion decides to deviate from the limits set by the dispatcher, an amended flight release is required.

Thus, although the traditional airline model provides some useful guidance, a new system of flight risk management is needed for the relatively inexperienced pilot who wishes to fly a VLJ. The present invention presents just such a solution.

### BRIEF SUMMARY OF THE INVENTION

The present invention comprises a Flight Risk Management System (“FRMS”). The system provides supplementary preflight and in-flight guidance to relatively inexperienced owner/operators of high performance aircraft. A pilot wishing to enroll in the FRMS must have an aircraft equipped with an in-flight data recorder capable of monitoring the aircraft's state and communicating this state to an FRMS dispatcher. The dispatcher analyzes each flight before its commencement and imposes restrictions designed to promote flight safety. The dispatcher monitors the flight in progress to ensure the pilot's compliance with all directives. For most enrollees, participation in the FRMS is a mandatory condition precedent to the pilot's insurance coverage. Thus, the potential loss of insurance coverage enforces compliance. In the preferred embodiment, the FRMS manages pilot training, pilot performance, aircraft maintenance, and flight risk assessment.

### DETAILED DESCRIPTION OF THE INVENTION

In the present inventive process, a flight dispatcher is used to assist a relatively inexperienced pilot in the planning and conduct of his or her flight. In order to perform this function, the flight dispatcher must have a significant amount of real-time information about the aircraft he or she is directing. It may therefore be helpful for the reader to generally understand the hardware involved, as well as its capabilities. Once this background information is disclosed, a thorough explanation of the inventive process will be easily comprehended.

Description—Flight Data Acquisition

The dispatcher would like to have: (1) Information regarding control input from the pilot; and (2) Information about the physical state of the aircraft. Control input from the pilot encompasses rudder position, aileron position, elevator position, throttle position, other engine control settings, flap settings, speed brake/spoiler settings, slat settings, landing gear position, and the like. Information about the physical state of the aircraft encompasses position (latitude/longitude), altitude, roll, pitch, and yaw. Many more variables can be monitored, including roll, pitch, and yaw rates, as well as vertical speed.

Those skilled in the art will know that Flight Data Recorders (FDR's) are presently able to monitor these functions. A brief explanation may be helpful: Information regarding control input can be obtained by using positional sensors on the controls themselves, on the moving control surfaces, or both. Information regarding the aircraft's physical state is often pulled from the instrumentation available to the pilot. The Attitude Indicator (sometimes known as an “Artificial Horizon”) provides accurate roll, pitch, and yaw data. The gyroscopes within this instrument are now often equipped with linear and angular accelerometers. Thus, an advanced Attitude Indicator can also provide roll rate, pitch rate, yaw rate, and linear accelerations in X, Y, and Z. The Altimeter provides an approximate altitude above sea level. The Vertical Speed Indicator (“VSI”) provides a rate of change in altitude. All these instruments now commonly provide digital outputs which can be fed into another system.

The recent widespread availability of in-cockpit GPS permits greater accuracy. A good GPS system can provide positional accuracy within 5 meters and altitude accuracy of around 10 m. This data tends to be absolute, thereby eliminating the uncertainty inherent in barometric Altimeters.

For aircraft which do not have rate gyros or sophisticated accelerometers, information as to roll, pitch, and yaw rates, as well as positional change rates, is not directly available. However, using a reasonably fast clock cycle in pulling data from the aircraft's instrumentation allows all these rates to be calculated with acceptable accuracy. Most GPS devices perform these rate calculations automatically, thereby providing reasonably accurate ΔX, ΔY, and ΔZ data.

It is also possible to monitor a variety of engine functions. In the case of a turbofan engine, these might include throttle input, engine RPM, fuel flow rate, and maximum exhaust gas temperature. Other critical systems can be measured as well. For aircraft having hydraulic controls, the pressure in each circuit can be monitored. For aircraft having fly-by-wire controls, the voltage and current on each control bus can be monitored.

Thus, the reader will realize that present aircraft instrumentation and data acquisition technology allows the following information to be collected and stored within the aircraft:

1. Position in X, Y, and Z;

2. Attitude in roll, pitch, and yaw;

3. Positional change rates in ΔX, ΔY, and ΔZ;

4. Attitude change rates;

5. Control input;

6. Control surface and landing gear positions;

7. Throttle and Engine Control Input;

8. Actual engine state;

9. Hydraulic pressure;

10. Power bus state; and

11. Fuel management.

Not all these parameters typically need to be monitored. In fact, the present inventive process can be implemented using only a few of them (described more fully in the subsequent disclosure). However, the reader should know that technology presently exists to monitor all these functions.

FDR's typically record these flight parameters for subsequent retrieval and evaluation. Thus, in the airline context, the aircraft's FDR might be downloaded once per day to evaluate the performance of the aircraft and its crew. An FDR can be configured to download much more frequently, however. It is preferable, in fact, for the FDR to provide this data to the FRMS on a near real-time basis.

Description—Communication Equipment

Data compression allows several minutes of flight data to be compressed to a one or two second radio frequency “burst transmission.” If an FDR is equipped with such a communication facility, it can automatically transmit flight data at fixed intervals (such as every one minute or every ten minutes). Further, this transmission rate can be adjusted depending on the circumstances. For a nominal flight where a dispatcher is just monitoring a pilot's progress, the FDR might be instructed to transmit updates once every ten minutes. If, on the other hand, circumstances indicate that the pilot needs closer monitoring, the dispatcher might command transmissions once every thirty seconds. It is even possible to generate a real-time transmission rate if the dispatcher perceives that a pilot is in trouble. Of course, since a higher transmission rate consumes the available communication bandwidth, the lowest rate needed to perform the job is preferred.

As an alternative, the on-board FDR could be configured to monitor the flight conditions and only transmit certain data in the event of an exceedance or near-exceedance. The reader should appreciate that the FRMS will not determine the limits for safe operation of a particular aircraft. These limits are set by the manufacturer and are specifically recited in the aircraft's Pilot Operations Handbook or Flight Operations Manual. Thus, since a particular FDR will be mounted within a particular aircraft, the relevant limits could be programmed right into the FDR. It would then look for an exceedance in flight. If an exceedance is detected, it might then compress 30 seconds of detailed flight data surrounding the event and transmit this to a receiving station along with a notice of the exceedance.

Ground-based receivers can be configured to receive these transmissions and relay them to the dispatcher assigned to the flight. This technology is presently implemented for cellular phone communications, where the position of the transmitter and receiver are continually updated to maintain a communications link. As an alternative, satellite-based communications, or UHF or VHF datalinks, may be employed. Whatever the method selected, the present invention ideally includes the ability to transmit the aircraft data back to the dispatcher while the plane is in flight. It is preferable to have communications from the dispatcher back to the pilot as well.

The actual dispatcher/pilot communication link can take several forms. One approach is to use text messages which are displayed on a monitor in the cockpit. The hardware would be similar to that used in the “ACARS” text messaging system presently employed by the airlines. Voice communications could also be provided. These would preferably employ a system wholly separate from the FAA-compliant communications system the pilot uses to communicate with air traffic controllers. Most communication would likely occur via the text displays but, in the event of an unusual occurrence, either the pilot or the dispatcher could resort to voice communication. Again, it is desirable to have this voice communication system be separate from the one used to communicate with air traffic control.

Description—Aircraft Database

All aircraft flying within the United States are required to have an FAA type certificate. All the aircraft of a particular type are therefore fairly standard. A database can be created which contains the relevant data for each aircraft type. The present inventive process contemplates the availability of more specific data for each particular aircraft. As an example, all modifications done to the aircraft over its service life, all avionics upgrades, all engine upgrades, and a repair and maintenance history would ideally be included.

Such detailed information could be very important to the dispatcher. If some aircraft of a particular type are fitted with de-icing boots while others are not, the dispatcher would need to consider this fact before approving a flight into potential icing conditions.

Thus, a detailed aircraft database will ideally be constructed in the implementation of the present invention. In addition to the general information known about a particular aircraft type, specific information as to the history of each particular aircraft within that type should be known.

The aircraft database also includes information regarding maintenance and overhauls. The expectation is that most individuals participating in the proposed flight risk management system will be owner/operators. In other words, the enrollee will likely be a pilot flying his or her own aircraft. In order to facilitate comprehensive risk management, the flight risk management system should also manage maintenance and overhaul of the aircraft. Thus, the database will be updated to include complete maintenance and overhaul histories for each aircraft.

Description—Pilot Database

One of the most critical features of the present invention is the provision of a detailed pilot database. This will start with the FAA license or licenses held by the pilot. Much more detailed information will be needed however, to include:

1. The number of hours flown by the pilot in each aircraft type;

2. The specific training programs completed by the pilot;

3. The number of landings the pilot has made at each airport, as well as the conditions present at the time of the landing (day, night, VFR, IFR, etc.);

4. The pilot's prior history of problems (missed approaches, excessive vertical speed on approach, aircraft overspeed, etc.). This data can be collected in terms of repetitions needed to obtain proficiency. The number of repetitions can then be statistically compared against a pilot peer group. A particular pilot's rating for a particular activity can then be compared against the activities in the proposed flight plan;

5. The pilot's prior history of flying in adverse conditions (bad weather, high-crosswind approaches, high/hot fields, etc.); and

6. The pilot's progression through the program outlined in the present inventive process.

From these descriptions it will be apparent that the database is continually updated. When a pilot enters the program, all the available data is collected and added to the database. The pilot may be required to gather and furnish any missing information as a condition precedent to joining the program. Additional requirements might include a battery of mandatory physiological and psychological tests to exclude high-risk candidates.

Once admitted, the database is continually updated to reflect new information gathered while the pilot is in the program. For instance, a pilot having limited experience may be barred from attempting landings in high/hot conditions. However, once the pilot has satisfactorily completed several such landings under the supervision of a more experienced pilot, the database may be updated to remove this restriction.

The FRMS will preferably establish high-risk scenarios in which a pilot must demonstrate proficiency under supervision. Many pilots do not develop proficiency in these circumstances because they habitually avoid them. Then, when confronted with an unavoidable occurrence, the pilot is unable to cope. The FRMS will ideally force such pilots to operate in such environments in order to gain proficiency.

Description—Aircraft Maintenance Program

All facilities performing aircraft maintenance and overhaul work on aircraft must be licensed by the FAA. The proposed Flight Risk Management System includes the concept of designating specific maintenance and overhaul facilities having demonstrated superior performance. Much like the Flight Risk Management System imposes requirements on its enrolled pilots which exceed the FAA's requirements, the Flight Risk Management System will impose similar heightened requirements on the qualifying maintenance and overhaul facilities.

Additionally, the FRMS will require independent verification from the maintenance and overhaul facilities to the FRMS. When an aircraft is due for work, the FRMS will notify the pilot. The aircraft will then not be cleared for flight until the FRMS has received confirmation from the qualified facility (rather than the pilot) that the work has been satisfactorily completed.

Description—Role of the Supervising Pilot

One aspect of the FRMS is the provision of supervising pilots. These pilots would have training comparable to airline pilots, and are therefore capable of handling most any flight conditions. When an FRMS-enrolled pilot proposes a flight which cannot be approved due to inadequate pilot experience, one option will be the provision of a supervising pilot to travel along and ensure the safety of the flight. One goal of the FRMS is to create an available network of such potential supervisor pilots. This network will ideally be broadly distributed throughout the U.S., and will likely consist of airline and corporate pilots who can be available when they are not flying their regular jobs.

Flight safety data clearly indicate that two pilots are better than one, even if both pilots have limited experience. Thus, the mere provision of a second pilot in challenging environments is likely to be helpful.

Description—Insurance Contract Enforcement

Unlike the FAA, the FRMS has no statutory authority to supervise or restrict the actions of its enrolled pilots. By definition, all enrolled pilots are duly licensed by the FAA and are considered fully capable of self-supervision. The FRMS seeks to impose restrictions in addition to those imposed by the FAA. An additional enforcement mechanism is therefore needed.

As stated at the outset of this disclosure, a primary goal of the FRMS is creating an environment in which otherwise uninsurable pilots can be insured. The existence of an insurance contract thereby creates the needed enforcement mechanism. The FRMS contemplates a three-party relationship between the pilot, the pilot's insurer, and the FRMS. The insurance contract provides that the pilot must follow all FRMS directives as a condition precedent to coverage. The contract also provides that the pilot must operate in a generally safe manner.

As a first example,. consider the case of a pilot ignoring an FRMS directive: The FRMS orders a pilot to land short of his destination because of a developing storm front. If the pilot ignores this directive, the contract provides that his coverage is voided immediately. In other words, the pilot is not covered for the remainder of that flight (and presumably thereafter).

As a second example, consider the case of post-flight data analysis: Assume for this example that the FRMS receives GPS altitude data. After the flight, a computer-generated analysis shows that the pilot exceeded the maximum recommended rate of descent on approach (This would indicate that the pilot was likely too high and should have gone around, but instead elected to press his luck on the landing). The database is accessed and the dispatcher notes that this particular pilot has had two prior similar episodes—after which he was debriefed and warned. At this time, the FRMS personnel notify the insurance carrier of the problem. The carrier may then elect to cancel coverage.

In some instances the insurance contract provision may not mandate outright compliance with all dispatcher directives. Rather, the insurance contract may only require that the pilot enroll in the FRMS and use the FRMS to manage the risk of the flight operations. The FRMS will use the aircraft and pilot databases to evaluate a pilot's performance and report a summary of this performance to the insurance carrier, essentially as a rating of risk for different situations. The carrier can then use this rating to set the monetary rate it charges for the coverage, increase or decrease the limits of coverage it is willing to offer, elect to continue or drop coverage for an existing enrollee, or elect to issue or deny coverage for a prospective enrollee.

The insurer can therefore use the data and summaries compiled by the FRMS in several ways. Some insurers may simply provide that an enrolled pilot must comply with all directives of the FRMS dispatcher as a condition of coverage. Other insurers may not mandate compliance but instead use the data on a pilot's rating of risk to set the insurance rates, limits of coverage, etc.

Specific examples of the operation of the FRMS will be given in the following text. However, the reader should bear in mind throughout that the insurance contract is the primary enforcement mechanism for all aspects of the FRMS.

Description—Role of the FRMS Dispatcher

Now that the reader understands the hardware, the databases, and the use of the insurance contract as an enforcement mechanism, the role of the dispatcher within the FRMS can be explained in detail.

Assume that a pilot/owner has just acquired a new high-performance VLJ. A fictitious aircraft name will be used (“BetaJet 100″). The BetaJet 100 is capable of sustained level flight at Mach 0.85. It is fully pressurized and has a service ceiling of 45,000 feet. The particular pilot has 2,000 hours of experience in light single engine and light twin engine aircraft. He holds an instrument rating and has completed all the FAA-mandated training to fly the BetaJet 100. However, the only time he has in aircraft at this performance level is the time he spent in the type training prior to acquiring his BetaJet 100.

Under the FAA regulations, the pilot is capable of flying the BetaJet 100 as he sees fit. Because of his lack of comparable experience, though, no insurance carrier is willing to provide coverage.

The pilot is referred to the FRMS (by the insurance carrier or other referring source). The pilot enrolls in the FRMS and obtains insurance coverage subject to the condition of his compliance with all FRMS directives. Depending on his experience, the pilot may initially be directed to complete certain training courses. In any event, once fully enrolled in the program, the pilot would engage in the following process prior to a flight:

Description—Pre-Flight Planning Example

The pilot (“Pilot John Smith”) contacts the FRMS dispatcher. This initial contact may be made via telephone, SMS text message, the Internet, or other suitable means. The pilot submits a proposed flight plan. As an example, the pilot may propose flying from Orlando, Fla. to Chicago, Ill., on October 1. The proposed departure time is 1530 EDT, with no planned stops.

The dispatcher accesses the aircraft database and learns that the aircraft is current on all maintenance and has avionics suitable for nighttime flying. The dispatcher next checks the weather forecast along the proposed route and learns that the weather is expected to be clear with good visibility along the entire flight path.

The dispatcher supplements the flight plan by creating several contingency destinations. These would include “land short” destinations along the route. The “land short destinations” are selected as Columbus, Ga., and Louisville, Ky. The dispatcher next selects an appropriate alternate destination in the event of a contingency (typically a weather problem) at the actual destination. Peoria, Ill. is selected as a suitable alternate destination.

The dispatcher then accesses the aircraft database to determine the BetaJet 100's fuel capacity and consumption rates. The dispatcher uses this information to determine the appropriate fuel load needed to maintain required flight-time margins. As an example, the fuel load might be the amount needed to make the trip, loiter 45 minutes over the actual destination, divert to the alternate destination, and land with 45 minutes of fuel remaining. At this point, the dispatcher is proceeding toward providing the information to the pilot.

At some point, however, the dispatcher checks the pilot database. This check reveals that Pilot Smith has very little nighttime flying experience. It also reveals that he has never flown into the Chicago area before. The dispatcher considers these facts—possibly comparing them to a predetermined risk matrix—and decides the flight must be disapproved.

The dispatcher's rationale is as follows: A 1530 EDT departure will produce an ETA of 1710 CDT, assuming no traffic delays or course deviations are encountered. Dusk at the destination airport will occur at 1750 CDT. Thus, if all goes well, the entire flight will be conducted in good light. However, there is very little room for delay. If the flight is delayed by Air Traffic Control, or has to divert to the alternate destination, the landing will likely occur in dusk or darkness. Because the pilot's history indicates that dusk or darkness presents an unacceptable risk, the flight must be disapproved.

Prior to contacting the pilot, the dispatcher considers alternatives which would avoid the unacceptable risk. The dispatcher then contacts the pilot and indicates that the proposed flight is disapproved. The following alternatives are presented:

1. The pilot must depart no later than 1400 EDT;

2. The pilot can depart as proposed (1530 EDT), but must land at Louisville, Ky. for an overnight stay, with the flight continuing the next morning (subject to continued approval); or

3. A supervising pilot can be provided to fly the aircraft with Pilot Smith, in which case the original schedule can be approved.

Pilot Smith can then choose among the alternatives presented. Significantly, the FRMS does not assume that a pilot's abilities remain stagnant. Training is a key component of the program. If Pilot Smith elects to accept the supervising pilot, the flight will still be conducted by Smith. Smith may actually choose to leave a bit later so that he can accumulate some nighttime flying hours. If he does so, the database will be updated to reflect this fact. Once Smith manages to accumulate an appropriate amount of nighttime hours, the FRMS dispatcher will no longer restrict that activity.

Of course, the dispatcher has many additional options to present in appropriate circumstances. For the preflight planning stage, these options include:

1. Rerouting a flight to avoid weather, with mandated way points (which the pilot must pass through in order to maintain insurance coverage);

2. Placing an altitude restriction on the flight (such as flying within the altitude region which is safe for non-pressurized flight);

3. Requiring the flight to make an intermediate stop, thereby preserving better fuel margins;

4. Requiring the flight to divert to a more favorable airport (such as one with a longer runway or easier terrain on approach); and

5. Delaying the flight to obtain anticipated visual meteorological conditions.

The initial example presented was for preflight planning. The reader will recall from the description of available hardware, however, that the dispatcher can monitor the flight in progress and communicate with the pilot. This is another key feature of the FRMS. In many instances, the pilot/owner will be the only trained person aboard the aircraft. Without outside help, he or she is responsible for flying, navigation, fuel management, and overall situational awareness. The dispatcher can assist with some of this workload.

As one example, the dispatcher can monitor fuel consumption and fuel safety margins while the flight is progressing. The dispatcher may intervene in the following ways:

1. Communicating weather updates and recommending appropriate course alterations;

2. Communicating any anomalies noted on the FDR data (such as high fuel consumption or high exhaust gas temperature);

3. Updating the flight plan if the weather changes at the destination airport; and

4. Contacting the pilot if FRMS directives are not being obeyed.

The dispatcher can also assist the pilot by gathering information. For example, the dispatcher can access resources not easily available to the pilot at the destination airport to learn about weather conditions in the approach path. The dispatcher can also contact Air Traffic Control to learn about expected delays. Thus, the reader will appreciate that in addition to directing the preflight planning, the dispatcher can also assume some of the pilot's in-flight workload.

Description—Weather Avoidance Example

In this example an enrolled pilot proposes a daytime flight from Atlanta to Cincinnati. The flight has initially been cleared for a direct route. Shortly after the pilot takes off, however, the dispatcher learns that a line of thunderstorms to the southeast of Cincinnati has extended further westward and now lies in the flight path. The dispatcher rechecks the aircraft and pilot database, learning that the pilot has limited experience flying IFR through turbulent weather. Continuing the flight on its present course therefore presents an unacceptable risk.

The dispatcher contacts the pilot and offers the following option:

1. Turn northwest and fly over Nashville, Tenn., before resuming course for Cincinnati (The dispatcher has first assured that the aircraft has an adequate fuel margin);

2. “Land short” in Knoxville, Tenn., and wait for the weather to pass; or

3. “Land short” in Knoxville, Tenn. and the dispatcher will arrange to provide a supervising pilot so that the flight can continue shortly thereafter.

The pilot elects to deviate his course to pass over Nashville. The dispatcher approves this plan and then monitors the flight to ensure that the aircraft actually does pass over the required way point before turning back toward Cincinnati.

Description—Fuel Management Example

In this example, Pilot Jones submits a flight plan proposing to fly directly from New Orleans, La., to Portland, Me. The dispatcher selects Syracuse, N.Y., as an alternate landing site. As the pilot has suitable experience for the proposed flight, it is then cleared without further limitations. The flight departs at 0800 CDT.

As Pilot Jones passes the flight's midpoint (1100 EDT), he is instructed by Air Traffic Control to enter a holding pattern near Charleston, W.Va. After ten minutes in the pattern, he contacts ATC requesting information as to the duration of the hold. ATC advises that they estimate releasing him in another 30 minutes.

Pilot Jones contacts the FRMS dispatcher to advise of the hold. He uses a text messaging system to relay this information (The communication could be by voice, text message, or other suitable means). The dispatcher uses text messaging to respond. In the response, the dispatcher advises that adverse weather in the Philadelphia and New York areas has caused the ATC to delay flights inbound to the region.

The dispatcher checks the weather as well as the pilot database. The weather at Portland and Syracuse remains favorable, and the flight should pass over the adverse weather conditions prevailing further south. The dispatcher advises Pilot Jones that the original flight plan is still in effect.

By 1250 EDT, Pilot Jones has heard nothing from ATC. He again contacts the dispatcher by text message. The dispatcher advises that fuel margins are fine to hold until 1340 EDT. The dispatcher also contacts ATC by telephone to inquire whether a deviation to westward in the flight plan would improve the situation.

At 1300 EDT, while the dispatcher is considering altering the flight plan, ATC releases Pilot Jones from the holding pattern and he proceeds toward Scranton, Pa. Pilot Jones, who is uncertain of his fuel margin, contacts the dispatcher. He advises of the release from hold and asks how much time is available for an additional hold should one be ordered.

At 1320 EDT, the dispatcher sends a reply text message stating that only 20 minutes of additional holding time are available, while leaving enough margin to miss the approach at Portland and still make it to Syracuse. Pilot Jones acknowledges and proceeds.

As the flight approaches Harrisburg, Pa., ATC orders another hold (1420 EDT). Pilot Jones is now quite concerned about his fuel status. He activates his voice link with the dispatcher and speaks directly. The dispatcher states that she has identified several “land short” alternates and is presently working a solution to substitute a closer missed-approach alternate for the originally designated one (Syracuse).

The dispatcher's rationale is as follows: Weather in the northeastern U.S. is by this time clear. The remaining ATC delays are the result of traffic congestion from earlier delays. Thus, she is now willing to accept a missed-approach alternate that is closer to Portland. She checks her database and reviews the air traffic situation before deciding on Concord, N.H.

Meanwhile, Pilot Jones has again called in over concern about his fuel state. The dispatcher speaks directly to Pilot Jones. She informs him that the missed-approach alternate is now Concord, N.H. She advises that so long as ATC releases the aircraft by 1500 EDT, he has sufficient fuel to continue to Portland. She also advises that she has worked out solutions for several “land short” destinations if those become necessary. Jones acknowledges.

At 1440 EDT, Jones sends a text message indicating that he has been released from the ATC hold. The flight proceeds forward uneventfully. The dispatcher monitors the aircraft's position and fuel status up to the final approach into Portland.

The reader will appreciate from this example how the dispatcher has assisted the pilot with some of the fuel management and navigational tasks. The reader will also appreciate that the dispatcher is able to easily communicate with other ground resources (ATC, control towers at various airports) in order to provide much more comprehensive contingency planning. The dispatcher also has the ability to request that the FAA contact the flight. This can be an important feature, since it serves as a redundant communications link in the event of a communications failure between the pilot and the dispatcher.

Description—Pilot Exceedance Example

All aircraft manufacturers specify aircraft performance parameters which are not to be exceeded. A few examples are:

1. Maximum air speed;

2. Maximum positive G-load;

3. Maximum negative G-load; and

4. Maximum allowable flap extension speed.

Other parameters are used to define good flying practices. An example of these might be a defined maximum descent rate. If a pilot's approach is too high, he or she may be inclined to cut power drastically and dive the aircraft to lower altitude. Such a maneuver may be accomplished without exceeding the aircraft's rated maximum air speed or maximum positive G-load. However, it is inherently much riskier than an approach along the proper glide slope. It often results in higher landing speeds and a greater potential for an overshoot.

A disciplined pilot, once passing a certain point on the approach and realizing that the aircraft is too high, will execute a missed approach and go around. Thus, a defined maximum descent rate can be used to define good flying practices. When this rate is exceeded, an “exceedance” has occurred.

The FRMS is designed to monitor a pilot's performance and check for exceedances. The FDR can monitor descent rate by monitoring the Vertical Speed Indicator (VSI), by comparing the output of the Altimeter over time, or by monitoring GPS absolute altitude over time. If an exceedance occurs, a message is sent back to the FRMS dispatcher. The pilot history database is then consulted. Time permitting, the dispatcher may actually order the pilot to abort the approach and go around.

If this is the first such exceedance, the pilot is contacted and instructed to schedule a mandatory debriefing within a short time. At this debriefing—which may be conducted via telephone—a highly trained pilot goes through the exceedance scenario with the enrolled pilot. The dangers of such maneuvers are reemphasized and the pilot is informed that his altitude on approach will be monitored in real time for his next landing.

If, on the other hand, there is a history of uncorrected exceedances, the insurance carrier is notified and the enrolled pilot's insurance coverage may be terminated.

Description—Aircraft Exceedance Example

As disclosed previously, an “exceedance” can also result from unusual aircraft engineering/maintenance issues. In this example, Pilot Jones is flying his BetaJet 100 from Atlanta, Ga., to Springfield, Mo. He is in level flight at an assigned cruising altitude. The on-board Flight Data Recorder is monitoring fuel consumption (as well as the other parameters discussed previously). Those familiar with aviation technology will know that for a given pitch/power relationship, an aircraft should have a predictable fuel consumption rate.

In this flight, the FDR notes that the fuel consumption rate is abnormally high. This constitutes an aircraft exceedance. An exceedance message is sent to the dispatcher and preferably to the pilot as well. This exceedance message will trigger an aircraft inspection when the plane lands. It likely indicates excessive drag, which may be the result of a loose flap or poorly rigged ailerons. Corrective action would then be ordered.

Some in-flight action may also be deemed appropriate. As an example, the dispatcher might contact Pilot Jones and ask him to evaluate the condition of the flaps. Jones reviews the flap settings and indicators on the instrument panel and confirms that they are fully retracted. Jones also asks a passenger—who is seated aft—to visually inspect the flaps. The passenger reports that the flaps are partially extended.

This information is relayed to the dispatcher. A voice discussion between the dispatcher and the pilot may ensue. The dispatcher can also contact the aircraft manufacturer seeking advice as to the implications of the problem. If a safety concern is raised, the dispatcher may order the pilot to land immediately and vector him to an appropriate airport.

Description—Weight and Balance Example

In this example, a pilot proposes making a relatively heavy takeoff in high/hot conditions. The FRMS dispatcher consults the aircraft database and learns that the aircraft's center of gravity must be carefully monitored under these conditions. The dispatcher also learns that this particular aircraft has been equipped with an auxiliary center fuel tank. Because this tank runs fore and aft, the database indicates that fuel flow aft in this tank can shift the aircraft's center of gravity rearward during takeoff rotation. The dispatcher sends a text message inquiring as to the status of the auxiliary tank.

The pilot responds that the center tank is holding about 80 pounds of fuel (a little more than one-half full). The dispatcher informs the pilot that the flight can only be cleared if:

1. The center tank is either completely full or completely empty; and

2. The pilot performs a weight and balance calculation to ensure that the aircraft's center of gravity is within the accepted range.

The dispatcher further requires the pilot to itemize and transmit the weight and balance calculations. As a result of this work, the pilot elects to completely fill the center tank, then shift some cargo forward. The aircraft is now much more pitch stable and better able to handle a heavy takeoff weight in the high/hot conditions.

Description—Pilot Graduation from FRMS

The FRMS anticipates that enrolled pilots will accumulate flying time in adverse conditions and will thereby incrementally “graduate” to more and more advanced flying. A pilot who has been enrolled in the program for a substantial amount of time may well become independently insurable with no further need for supervision by the FRMS. Thus, over time, enrolled pilots are expected to need less and less FRMS intervention.

However, the reader should appreciate that even very advanced pilots may wish to remain enrolled in the FRMS. An ATP-rated pilot, as an example, is accustomed to flying professionally with two extremely well qualified pilots in the cockpit. The presence of two pilots helps when dealing with contingency planning, fuel management, developing weather systems, and all the other hazards of flying.

An ATP-rated pilot who wishes to operate his or her own VLJ may therefore desire to enroll in the FRMS. Such a pilot may not use all the FRMS services, but may nevertheless wish to have access to a dispatcher in the event of difficult circumstances. The FRMS will therefore be made available to these more advanced pilots as well. And, because the FRMS represents a second “set of eyes” continuously monitoring and intervening in all aspects of risk, even a very experienced enrolled pilot should receive a reduced insurance rate.

The implementation of the FRMS may be different for these enrollees, since it is likely that an ATP-rated pilot would be able to obtain insurance coverage without the risk management system. The insurance contract would likely not contain a clause mandating compliance with all of the dispatcher's directives. The dispatcher's role would therefore change from that of issuing commands to more of a consulting role. The dispatcher would perform the same reviews of the pilot, aircraft, and weather databases. However, the dispatcher would offer his or her opinion to the ATP-rated pilot rather than issuing a mandatory directive.

Although the preceding descriptions present a great deal of detail concerning the FRMS, they should properly be viewed as providing examples of the embodiments of the invention rather than limitations of scope. Accordingly, the scope of the invention should be fixed by the claims presented and not by any particular example.

1. A method of managing risk of flight operations for a pilot operating an aircraft, comprising:
a. providing flight data monitoring means on said aircraft for monitoring flight data of said aircraft;
b. providing a dispatcher who is trained to monitor and supervise said flight operations, and to issue directives to said pilot;
c. providing flight data communication means on said aircraft for communicating said flight data from said aircraft to said dispatcher so that said dispatcher can monitor said flight data;
d. providing communication means between said dispatcher and said pilot so that said dispatcher can communicate said directives to said pilot; and
e. providing an insurance contract providing insurance coverage for said aircraft, wherein said insurance contract only provides said insurance coverage if said pilot complies with said directives issued by said dispatcher.

2. A method as recited in claim 1, further comprising providing an aircraft database accessible to said dispatcher, wherein said aircraft database provides data on said aircraft to said dispatcher.

3. A method as recited in claim 1, further comprising providing a pilot database, wherein said pilot database provides data on said pilot to said dispatcher.

4. A method as recited in claim 2, further comprising providing a pilot database, wherein said pilot database provides data on said pilot to said dispatcher.

5. A method as recited in claim 2, wherein said aircraft database is periodically updated to include all maintenance, repairs, and modifications performed on said aircraft.

6. A method as recited in claim 3, wherein said pilot database is periodically updated to include all training received by said pilot and said pilot's actual flight history.

7. A method as recited in claim 1, wherein said flight operations are governed in part by directives issued by air traffic control, further comprising providing communication means between said dispatcher and said air traffic control.

8. A method as recited in claim 2, further comprising:
a. providing a proposed flight plan for said aircraft to said dispatcher;
b. having said dispatcher compare said proposed flight plan to said aircraft database in order to determine whether said proposed flight plan is an unacceptable risk; and
c. having said dispatcher issue a directive disapproving said proposed flight plan if said proposed flight plan is an unacceptable risk.

9. A method as recited in claim 3, further comprising:
a. providing a proposed flight plan for said aircraft to said dispatcher;
b. having said dispatcher compare said proposed flight plan to said pilot database in order to determine whether said proposed flight plan is an unacceptable risk; and
c. having said dispatcher issue a directive disapproving said proposed flight plan if said proposed flight plan is an unacceptable risk.

10. A method as recited in claim 4, further comprising:
a. providing a proposed flight plan for said aircraft to said dispatcher;
b. having said dispatcher compare said proposed flight plan to said pilot database in order to determine whether said proposed flight plan is an unacceptable risk with respect to said pilot's abilities;
c. having said dispatcher compare said proposed flight plan to said aircraft database in order to determine whether said proposed flight plan is an unacceptable risk with respect to said aircraft's abilities; and
d. having said dispatcher issue a directive disapproving said proposed flight plan if said proposed flight plan is an unacceptable risk.

11. A method as recited in claim 2, further comprising:
a. providing a proposed flight plan for said aircraft to said dispatcher;
b. periodically updating said proposed flight plan with said flight data from said aircraft in order to create a revised flight plan;
c. having said dispatcher compare said revised flight plan to said aircraft database in order to determine whether said revised flight plan is an unacceptable risk; and
d. having said dispatcher issue a directive disapproving said revised flight plan if said revised flight plan is an unacceptable risk.

12. A method as recited in claim 3, further comprising:
a. providing a proposed flight plan for said aircraft to said dispatcher;
b. periodically updating said proposed flight plan with said flight data from said aircraft in order to create a revised flight plan;
c. having said dispatcher compare said revised flight plan to said pilot database in order to determine whether said revised flight plan is an unacceptable risk; and
d. having said dispatcher issue a directive disapproving said revised flight plan if said revised flight plan is an unacceptable risk.

13. A method as recited in claim 4, further comprising:
a. providing a proposed flight plan for said aircraft to said dispatcher;
b. periodically updating said proposed flight plan with said flight data from said aircraft in order to create a revised flight plan;
c. having said dispatcher compare said revised flight plan to said pilot database in order to determine whether said revised flight plan is an unacceptable risk with respect to said pilot's abilities;
d. having said dispatcher compare said revised flight plan to said aircraft database in order to determine whether said revised flight plan is an unacceptable risk with respect to said aircraft's abilities; and
e. having said dispatcher issue a directive disapproving said revised flight plan if said revised flight plan is an unacceptable risk.

14. A method as recited in claim 2, further comprising:
a. providing a proposed flight plan for said aircraft to said dispatcher;
b. providing a weather database accessible to said dispatcher, wherein said weather database provides weather data for a geographic region including said proposed flight plan;
c. having said dispatcher compare said proposed flight plan to weather data for said geographic region including said proposed flight plan in order to determine whether said proposed flight plan is an unacceptable risk; and
d. having said dispatcher issue, a directive disapproving said proposed flight plan if said proposed flight plan is an unacceptable risk.

15. A method as recited in claim 3, further comprising:
a. providing a proposed flight plan for said aircraft to said dispatcher;
b. providing a weather database accessible to said dispatcher, wherein said weather database provides weather data for a geographic region including said proposed flight plan;
d. having said dispatcher compare said proposed flight plan to weather data for said geographic region including said proposed flight plan in order to determine whether said proposed flight plan is an unacceptable risk; and
e. having said dispatcher issue a directive disapproving said proposed flight plan if said proposed flight plan is an unacceptable risk.

16. A method as recited in claim 4, further comprising:
a. providing a proposed flight plan for said aircraft to said dispatcher;
b. providing a weather database accessible to said dispatcher, wherein said weather database provides weather data for a geographic region including said proposed flight plan;
d. having said dispatcher compare said proposed flight plan to weather data for said geographic region including said proposed flight plan in order to determine whether said proposed flight plan is an unacceptable risk; and
e. having said dispatcher issue a directive disapproving said proposed flight plan if said proposed flight plan is an unacceptable risk.

17. A method as recited in claim 2, further comprising:
a. providing a proposed flight plan for said aircraft to said dispatcher;
b. periodically updating said proposed flight plan with said flight data from said aircraft in order to create a revised flight plan;
c. providing a weather database accessible to said dispatcher, wherein said weather database provides weather data for a geographic region including said revised flight plan;
d. having said dispatcher compare said revised flight plan to weather data for said geographic region including said revised flight plan in order to determine whether said revised flight plan is an unacceptable risk; and
e. having said dispatcher issue a directive disapproving said revised flight plan if said revised flight plan is an unacceptable risk.

18. A method as recited in claim 3, further comprising:
a. providing a proposed flight plan for said aircraft to said dispatcher;
b. periodically updating said proposed flight plan with said flight data from said aircraft in order to create a revised flight plan;
c. providing a weather database accessible to said dispatcher, wherein said weather database provides weather data for a geographic region including said revised flight plan;
d. having said dispatcher compare said revised flight plan to weather data for said geographic region including said revised flight plan in order to determine whether said revised flight plan is an unacceptable risk; and
e. having said dispatcher issue a directive disapproving said revised flight plan if said revised flight plan is an unacceptable risk.

19. A method as recited in claim 4, further comprising:
a. providing a proposed flight plan for said aircraft to said dispatcher;
b. periodically updating said proposed flight plan with said flight data from said aircraft in order to create a revised flight plan;
c. providing a weather database accessible to said dispatcher, wherein said weather database provides weather data for a geographic region including said revised flight plan;
d. having said dispatcher compare said revised flight plan to weather data for said geographic region including said revised flight plan in order to determine whether said revised flight plan is an unacceptable risk; and
e. having said dispatcher issue a directive disapproving said revised flight plan if said revised flight plan is an unacceptable risk.

20. A method as recited in claim 8, wherein if said dispatcher disapproves said proposed flight plan, having said dispatcher provide alternatives to said pilot which will allow said proposed flight plan to be modified and then approved.

21. A method as recited in claim 20, wherein said alternatives are selected from the group consisting of: the provision of an approved copilot, the designation of time restrictions on said proposed flight plan, the designation of an altitude restriction on said proposed flight plan, the designation of an intermediate stop on said proposed flight plan, and the designation of an alternate route for said proposed flight plan.

22. A method as recited in claim 9, wherein if said dispatcher disapproves said proposed flight plan, having said dispatcher provide alternatives to said pilot which will allow said proposed flight plan to be modified and then approved.

23. A method as recited in claim 22, wherein said alternatives are selected from the group consisting of: the provision of an approved copilot, the designation of time restrictions on said proposed flight plan, the designation of an altitude restriction on said proposed flight plan, the designation of an intermediate stop on said proposed flight plan, and the designation of an alternate route for said proposed flight plan.

24. A method as recited in claim 10, wherein if said dispatcher disapproves said proposed flight plan, having said dispatcher provide alternatives to said pilot which will allow said proposed flight plan to be modified and then approved.

25. A method as recited in claim 24, wherein said alternatives are selected from the group consisting of: the provision of an approved copilot, the designation of time restrictions on said proposed flight plan, the designation of an altitude restriction on said proposed flight plan, the designation of an intermediate stop on said proposed flight plan, and the designation of an alternate route for said proposed flight plan.

26. A method as recited in claim 1, wherein said flight data communication means stores said flight data and transmits said flight data to said dispatcher at fixed transmission intervals.

27. A method as recited in claim 26, wherein said dispatcher has the ability to vary said transmission intervals for said flight data.

28. A method as recited in claim 2, wherein said flight data communication means stores said flight data and transmits said flight data to said dispatcher at fixed transmission intervals.

29. A method as recited in claim 28, wherein said dispatcher has the ability to vary said transmission intervals for said flight data.

30. A method as recited in claim 3, wherein said flight data communication means stores said flight data and transmits said flight data to said dispatcher at fixed transmission intervals.

31. A method as recited in claim 30, wherein said dispatcher has the ability to vary said transmission intervals for said flight data.

32. A method of managing risk of flight operations for a pilot operating an aircraft, comprising:
a. providing flight data monitoring means on said aircraft for monitoring flight data of said aircraft;
b. providing a dispatcher who is trained to assist said pilot in said flight operations;
c. providing flight data communication means on said aircraft for communicating said flight data from said aircraft to said dispatcher so that said dispatcher can monitor said flight data;
d. providing communication means between said dispatcher and said pilot so that said dispatcher can communicate with said pilot;
e. providing an aircraft database accessible to said dispatcher, wherein said aircraft database provides data on said aircraft to said dispatcher;
f. providing a pilot database, wherein said pilot database provides data on said pilot to said dispatcher, including said pilot's training and flight history; and
g. updating said aircraft database and said pilot database so that said dispatcher can retrieve current data on said aircraft and said pilot.

33. A method as recited in claim 32, further comprising:
a. providing a proposed flight plan for said aircraft to said dispatcher;
b. having said dispatcher compare said proposed flight plan to said aircraft database in order to determine whether said proposed flight plan is an unacceptable risk; and
c. if said proposed flight plan is deemed an unacceptable risk, having said dispatcher use said communication means between said dispatcher and said pilot to inform said pilot of said dispatcher's opinion that said proposed flight plan is an unacceptable risk.

34. A method as recited in claim 33, further comprising:
a. providing a weather database accessible to said dispatcher, wherein said weather database provides weather data for a geographic region including said proposed flight plan;
c. having said dispatcher compare said proposed flight plan to weather data for said geographic region including said proposed flight plan in order to determine whether said proposed flight plan is an unacceptable risk; and
d. if said proposed flight plan is deemed an unacceptable risk, having said dispatcher use said communication means between said dispatcher and said pilot to inform said pilot of said dispatcher's opinion that said proposed flight plan is an unacceptable risk.

36. A method as recited in claim 32, further comprising:
a. providing a proposed flight plan for said aircraft to said dispatcher;
b. periodically updating said proposed flight plan with said flight data from said aircraft in order to create a revised flight plan;
c. having said dispatcher compare said revised flight plan to said aircraft database in order to determine whether said revised flight plan is an unacceptable risk; and
d. if said proposed flight plan is deemed an unacceptable risk, having said dispatcher use said communication means between said dispatcher and said pilot to inform said pilot of said dispatcher's opinion that said proposed flight plan is an unacceptable risk.

37. A method as recited in claim 36, further comprising:
a. providing a weather database accessible to said dispatcher, wherein said weather database provides weather data for a geographic region including said revised flight plan;
c. having said dispatcher compare said revised flight plan to weather data for said geographic region including said revised flight plan in order to determine whether said revised flight plan is an unacceptable risk; and
d. if said revised flight plan is deemed an unacceptable risk, having said dispatcher use said communication means between said dispatcher and said pilot to inform said pilot of said dispatcher's opinion that said revised flight plan is an unacceptable risk.

38. A method as recited in claim 33, wherein if said dispatcher informs said pilot of said dispatcher's opinion that said proposed flight plan is an unacceptable risk, having said dispatcher provide alternatives to said pilot which will allow said proposed flight plan to be modified in order to reduce said risk.

39. A method as recited in claim 38, wherein said alternatives are selected from the group consisting of: the provision of an approved copilot, the designation of time restrictions on said proposed flight plan, the designation of an altitude restriction on said proposed flight plan, the designation of an intermediate stop on said proposed flight plan, and the designation of an alternate route for said proposed flight plan.

40. A method as recited in claim 36, wherein if said dispatcher informs said pilot of said dispatcher's opinion that said revised flight plan is an unacceptable risk, having said dispatcher provide alternatives to said pilot which will allow said revised flight plan to be modified in order to reduce said risk.

41. A method as recited in claim 40, wherein said alternatives are selected from the group consisting of: the provision of an approved copilot, the designation of time restrictions on said proposed flight plan, the designation of an altitude restriction on said proposed flight plan, the designation of an intermediate stop on said proposed flight plan, and the designation of an alternate route for said proposed flight plan.

42. A method of managing risk of flight operations for a pilot operating an aircraft, comprising:
a. providing flight data monitoring means on said aircraft for monitoring flight data of said aircraft;
b. providing a dispatcher who is trained to assist said pilot in said flight operations;
c. providing flight data communication means on said aircraft for communicating said flight data from said aircraft to said dispatcher so that said dispatcher can monitor said flight data;
d. providing communication means between said dispatcher and said pilot so that said dispatcher can communicate with said pilot;
e. providing an aircraft database accessible to said dispatcher, wherein said aircraft database provides data on said aircraft to said dispatcher;
f. providing a pilot database, wherein said pilot database provides data on said pilot to said dispatcher, including said pilot's training and flight history;
g. updating said aircraft database and said pilot database so that said dispatcher can retrieve current data on said aircraft and said pilot; and
h. analyzing said aircraft database and said pilot database in order to determine the risk associated with said pilot performing said flight operations.

43. A method as recited in claim 42, further comprising:
a. providing an insurance contract providing insurance coverage for said aircraft; and
b. wherein the amount of coverage provided under said insurance policy is determined in part by said risk associated with said pilot performing said flight operations.

44. A method as recited in claim 42, further comprising:
a. providing an insurance contract providing insurance coverage for said aircraft; and
b. wherein the rate charged for said provision of said insurance policy is determined in part by said risk associated with said pilot performing said flight operations.
